(19) United States
(12) Patent Application Publication
(10) Pub. No.: US 2007/0097795 A1
(43) Pub. Date: May 3, 2007

(54) Timepiece with a calendar function and/or a time setting function, and method of assembling the timepiece

(75) Inventors: Hiroyuki Hosobuchi, Iruma-shi (JP); Takashi Suizu, Tokyo (JP); Mitsunobu Yatabe, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: CASIO COMPUTER CO., LTD.

(21) Appl. No.: 11/584,985

(22) Filed: Oct. 23, 2006

(30) Foreign Application Priority Data
Oct. 27, 2005 (JP) 2005-312667

(51) Int. Cl. G04B 19/24

(52) U.S. Cl. 368/37

(57) ABSTRACT

A timepiece with a calendar function. The timepiece includes a main plate (19) has a plurality of holes (76) arranged along the outer periphery of a ring-like day indicator (26) when the same is disposed concentrically on the main plate. When positioned, the day indicator (26) is disposed substantially concentrically with the main plate (19). When a plurality of guide pins (77) are inserted into the plurality of holes (76), respectively, in the main plate 19, the guide pins (77) cooperate to come into contact with the outer periphery of the day indicator to adjust the position of the day indicator (26) in radial directions, thereby positioning the day indicator exactly concentrically with and on the main plate (19) (FIG. 18).

### BACKGROUND OF THE INVENTION

1. Technical Field

The present invention relates to timepieces and more particularly to timepieces with a calendar function to display a date and/or a time setting function to set the time by receiving a standard time and frequency signal, and methods of assembling the timepiece.

2. Background Art

In the past, timepieces with a calendar function to display a date comprise a ring-like day indicator, on which a series of dates are printed, disposed rotatably and concentrically on a main plate, and a date indicator drive wheel meshing rotatably with gear teeth provided along the inner periphery of the day indicator such that the day indicator is rotated by rotation of the day indicator drive wheel.

With such a timepiece with a calendar function as disclosed especially in Unexamined Japanese Patent Publication 2004-144482, in order to dispose the day indicator rotatably and concentrically on the main plate the ring-like day indicator comprises a guide cylinder provided coaxially therewith on a lower surface of the inner peripheral part thereof, wherein the gear teeth are provided along the inner periphery of the guide cylinder, and a plurality of rolls are provided rotatable on the main plate so as to rotate in contact with the outer periphery of the guide cylinder, thereby guiding the day indicator.

However, the structure of the timepiece is complicated, the number of parts of the timepiece is great and the assembling operation is complicated. Especially, the plurality of rolls must be provided on the main plate so as to be in contact with the outer periphery of the guide cylinder of the day indicator. Therefore, high attachment accuracy is required and the assembling operation is troublesome.

### SUMMARY OF THE INVENTION

The present invention provides a timepiece with a calendar function/time setting function, which has a simply structure and is easy to assemble and a method of assembling the timepiece.

The objects, features and advantages of the present invention will become apparent in the following detailed description of the present embodiment and modifications thereof when read in conjunction with the accompanying drawings wherein the same reference numerals denote like or similar parts throughout the several views.

### BRIEF DESCRIPTION OF THE INVENTION

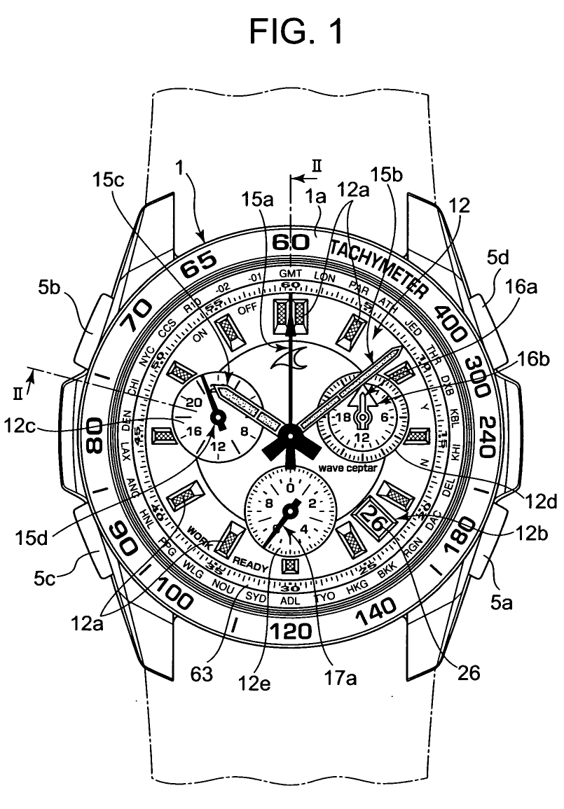

FIG. 1 is a front view of a wristwatch in accordance with an embodiment of the present invention;

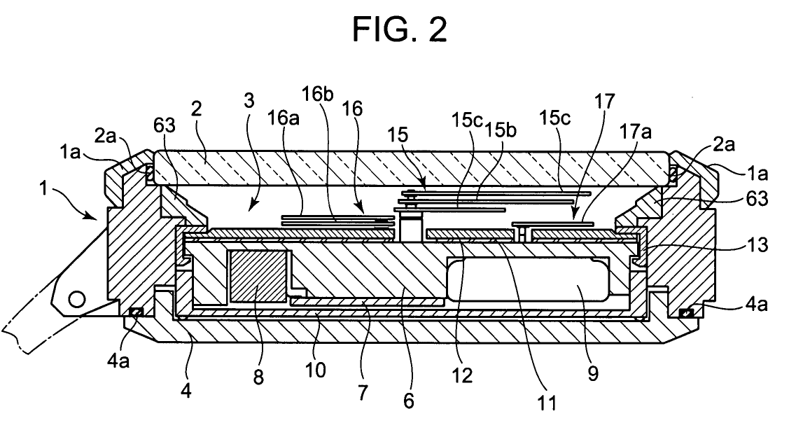

FIG. 2 is a cross sectional view taken along a line II-II in FIG. 1;

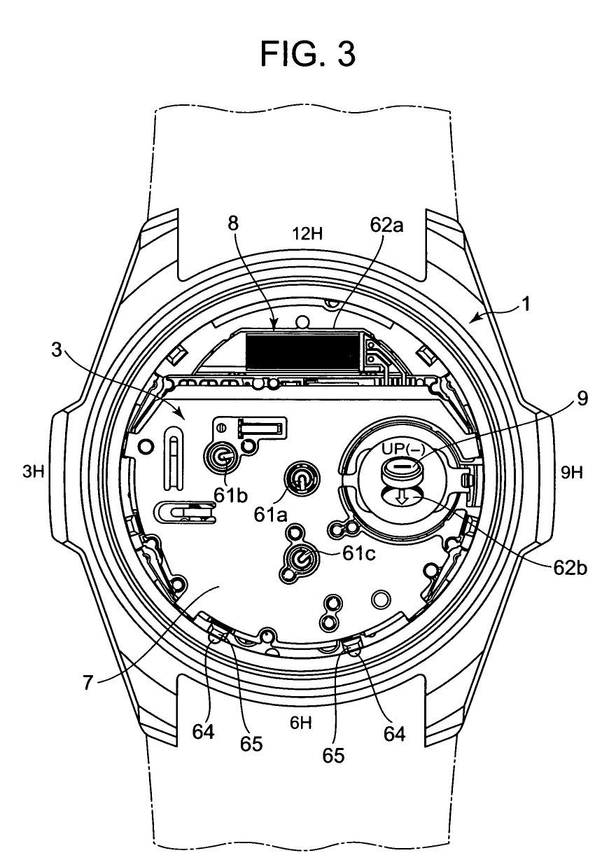

FIG. 3 is a bottom view of the FIG. 1 wristwatch with a case back removed;

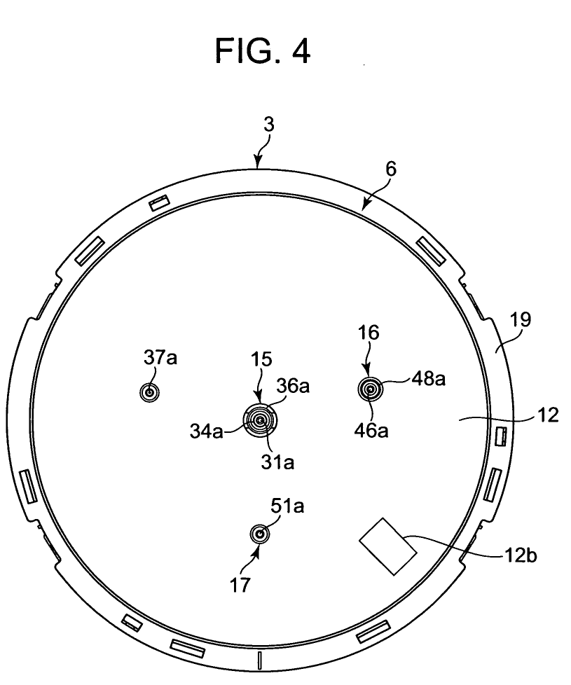

FIG. 4 is a front view of a timepiece module of the FIG. 1 wristwatch;

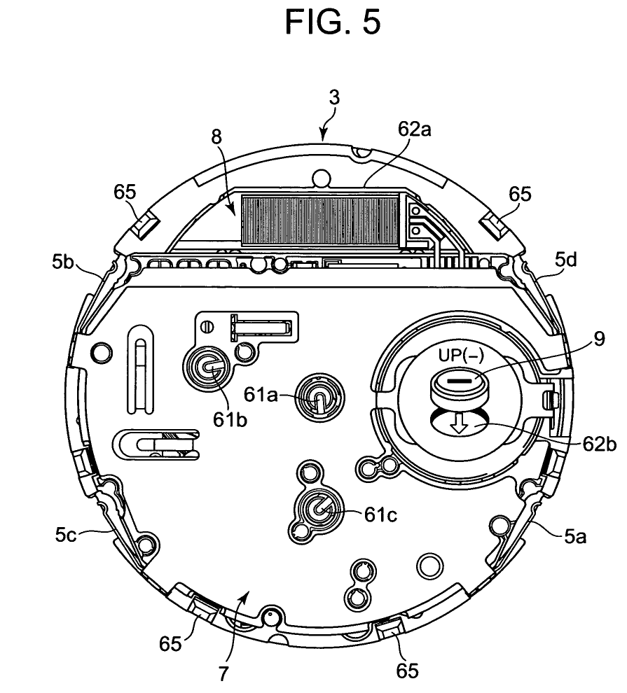

FIG. 5 is a bottom view of the FIG. 4 timepiece module;

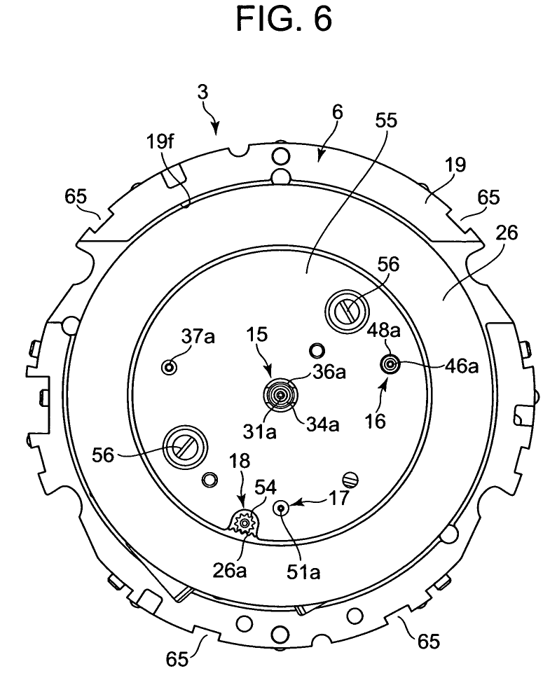

FIG. 6 is a front view of the FIG. 4 timepiece module with a solar panel and a dial plate removed;

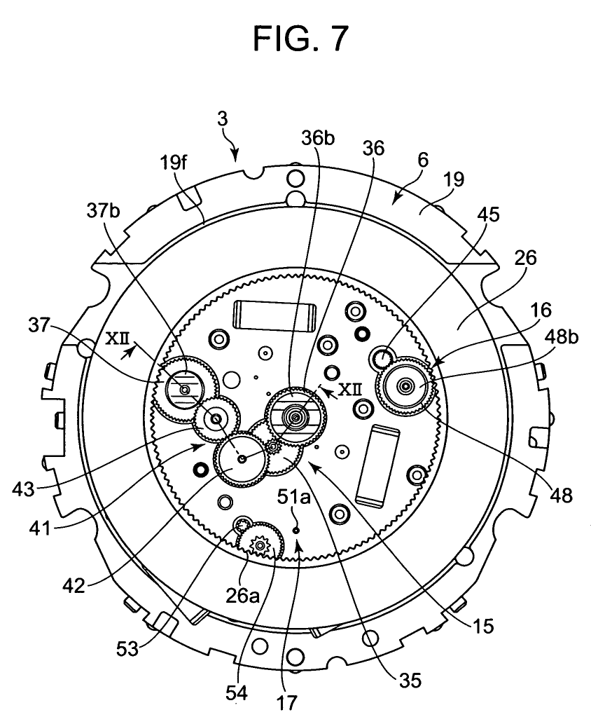

FIG. 7 is a front view of the FIG. 6 timepiece module with a day indicator maintaining plate removed;

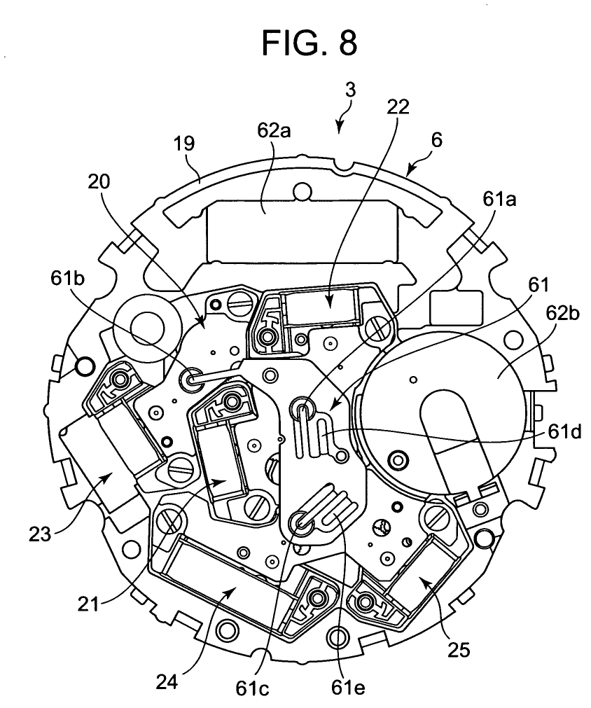

FIG. 8 is a bottom view of the FIG. 5 timepiece module with a circuit board removed;

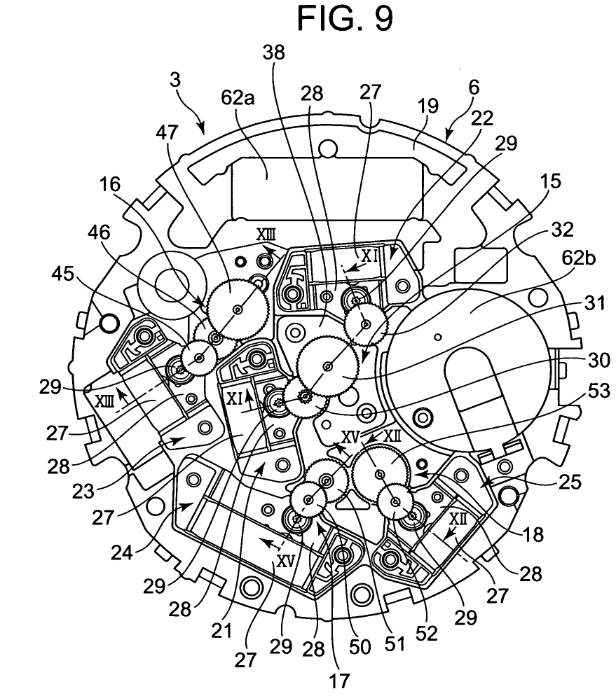

FIG. 9 is a bottom view of the FIG. 8 timepiece module with a wheel train bridge removed;

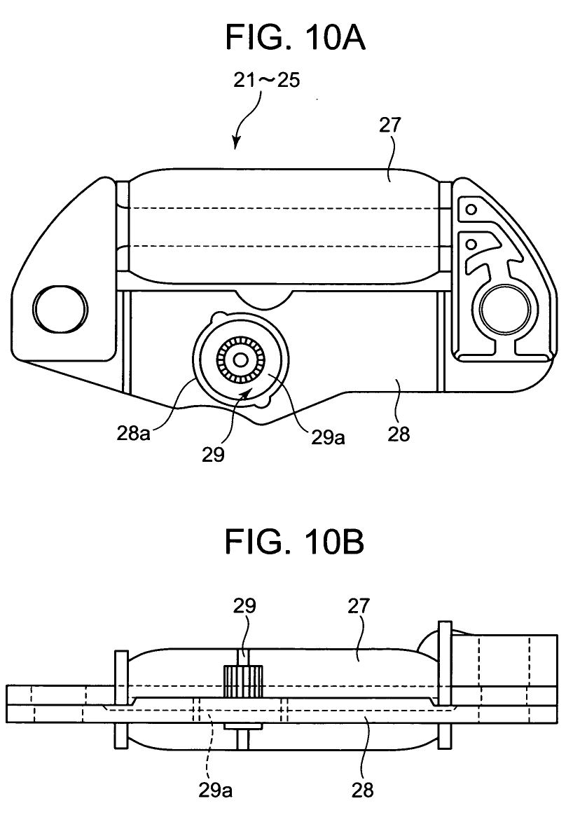

FIG. 10A is an enlarged front view of each of #1-#5 pulse motors of the FIG. 8 and 9 timepiece module;

FIG. 10B is an enlarged side view of that motor of FIG. 10A;

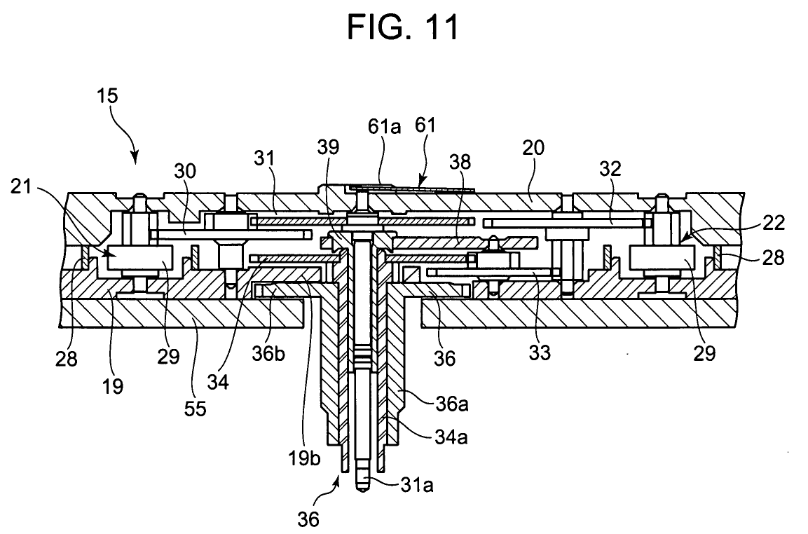

FIG. 11 is a cross sectional view of a three-hand wheel train taken along a line XI-XI of FIG. 9;

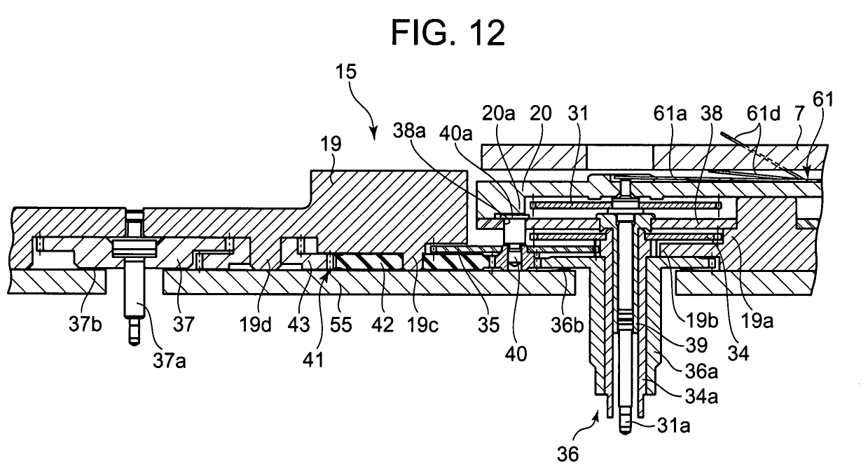

FIG. 12 is an upside down cross sectional view of a three-hand wheel train taken along a line XII-XII of FIG. 7;

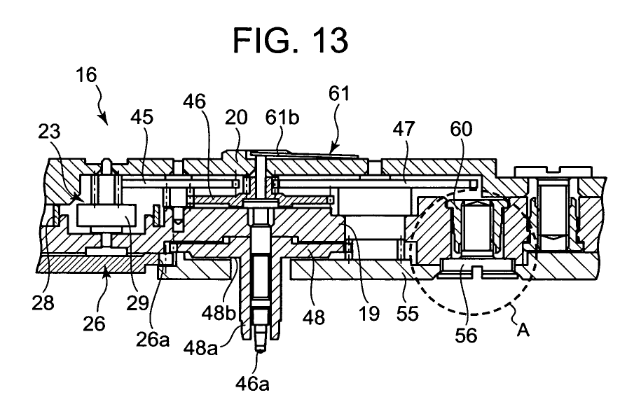

FIG. 13 is a cross sectional view of a two-hand wheel train taken along a line XIII-XIII of FIG. 9;

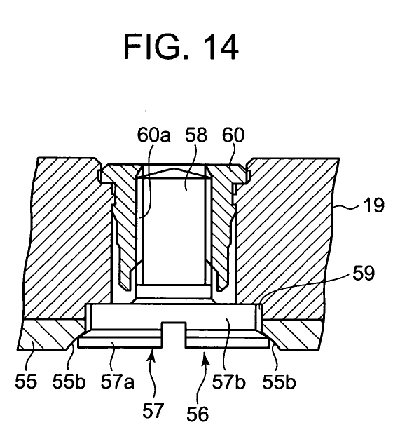

FIG. 14 is an enlarged cross sectional view of a part A of FIG. 13 involving a fixing screw and its vicinities;

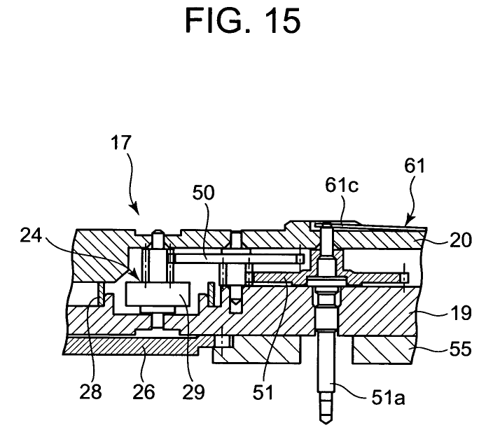

FIG. 15 is a cross sectional view of a second-hand-dedicated wheel train taken along a line XV-XV of FIG. 9;

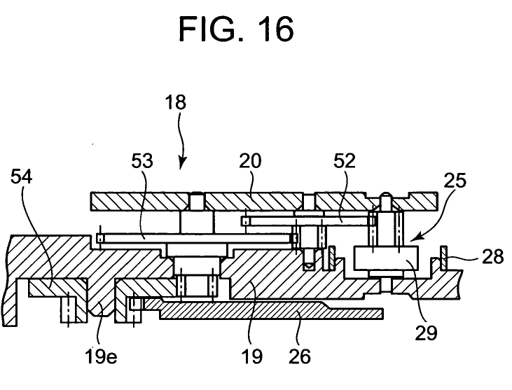

FIG. 16 is a cross sectional view of a day indicator wheel train taken along a line XVI-XVI of FIG. 9;

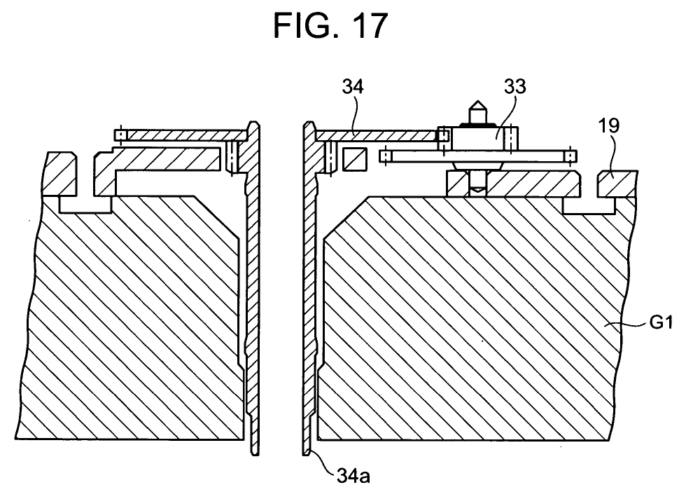

FIG. 17 is an enlarged cross sectional view of a second hand wheel of the FIG. 11 three-hand wheel train positioned on the main plate with a jig;

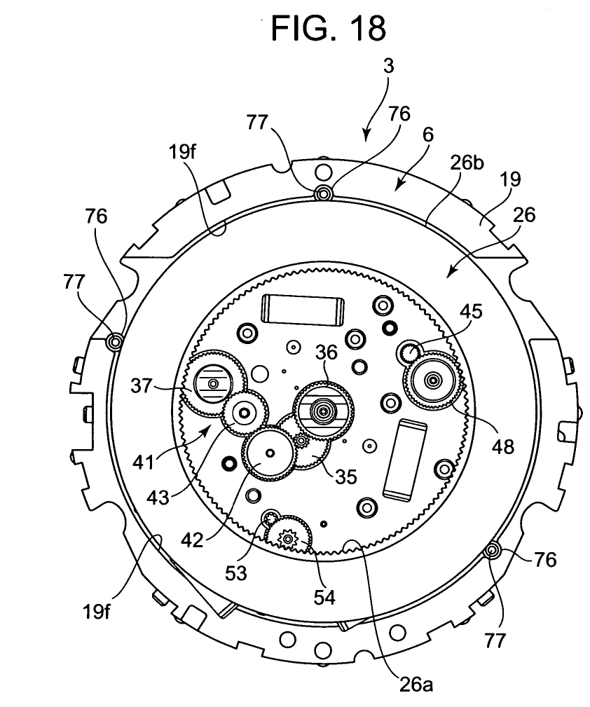

FIG. 18 is a front view of the timepiece module of FIG. 1, illustrating positioning of the day indicator;

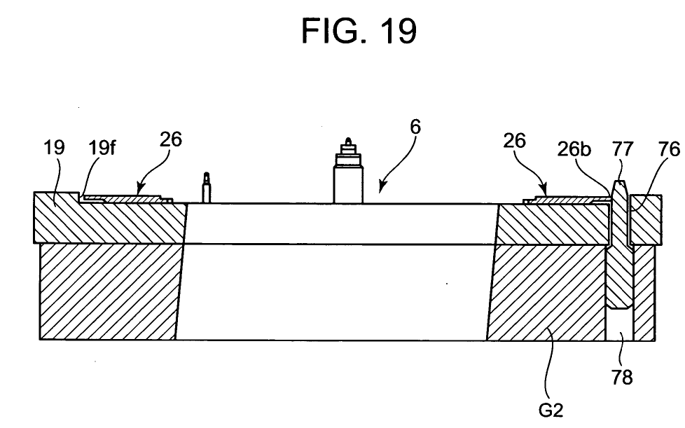

FIG. 19 is a cross sectional view taken in FIG. 18;

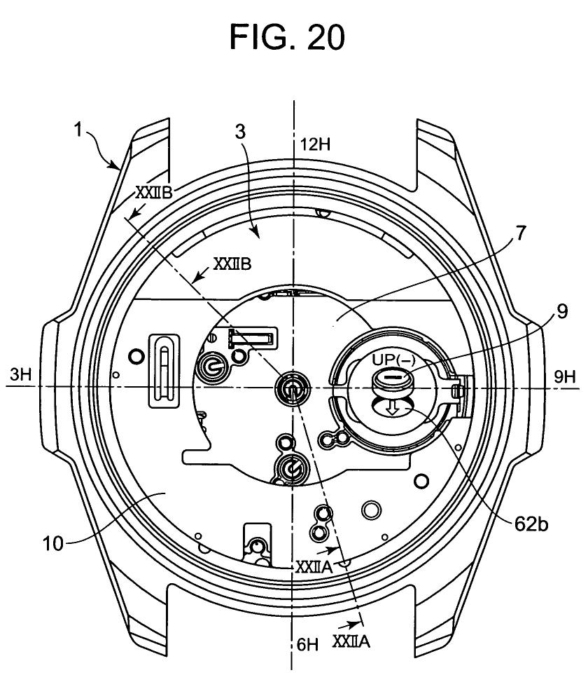

FIG. 20 is a bottom view of the wristwatch where the FIG. 3 timepiece module is positioned within the case by a module support;

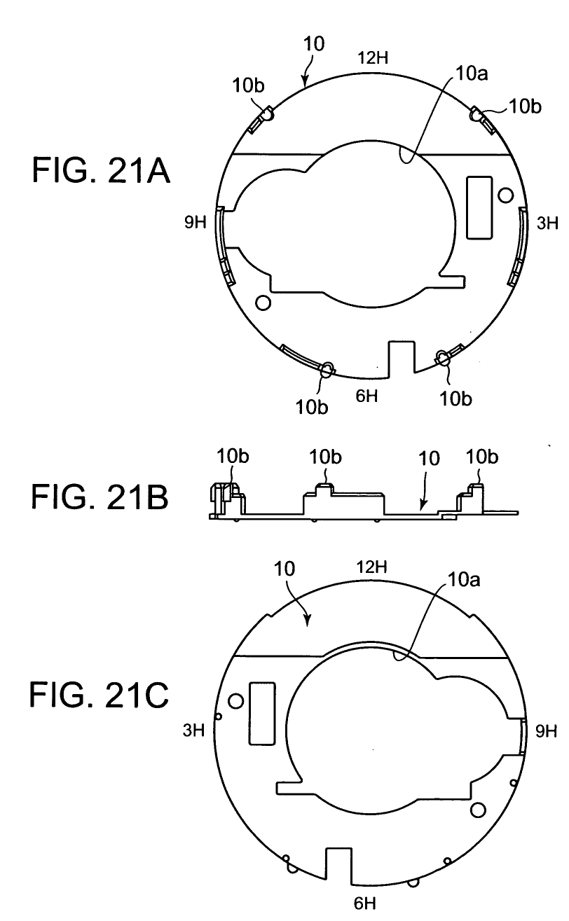

FIG. 21A is a front view of the module support of FIG. 20;

FIG. 21B is a side view of the module support of FIG. 20;

FIG. 21C is a bottom view of the module support of FIG. 20;

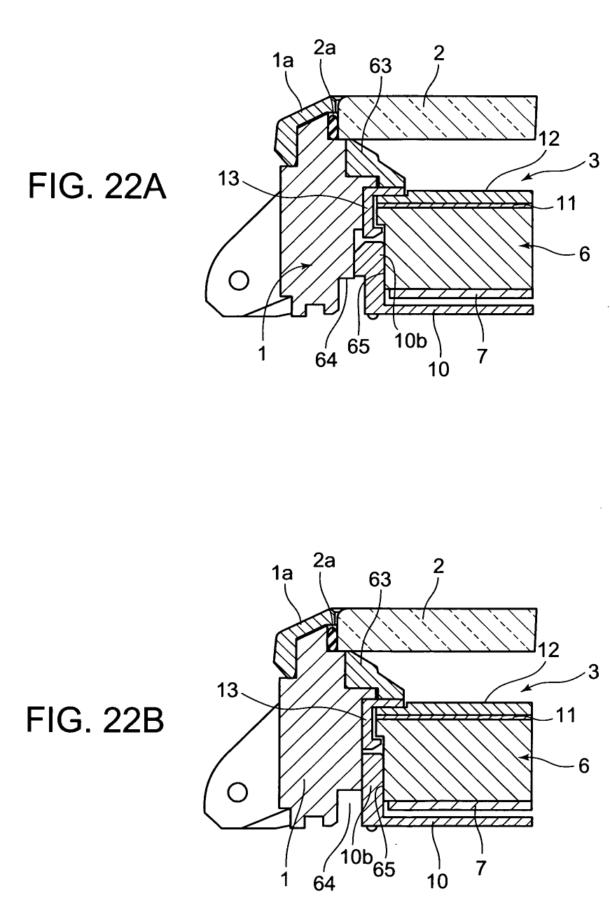

FIG. 22A is a cross sectional view taken along a line XXIIA-XXIIA of FIG. 20;

FIG. 22B is a cross sectional view taken along a line XXIIB-XXIIB of FIG. 20;

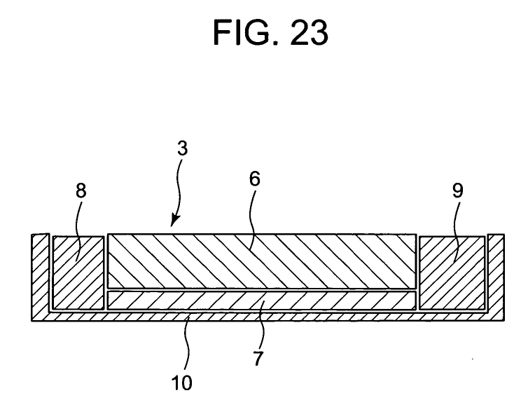

FIG. 23 is a schematic enlarged cross sectional view of a timepiece module of the first modification of the embodiment; and

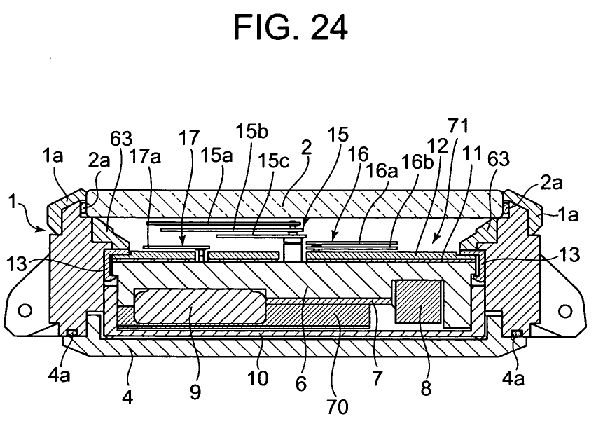

FIG. 24 is an enlarged cross sectional view of a second modification.

### DETAILED DESCRIPTION OF THE EMBODIMENT

Referring to FIGS. 1-22B, a multi-hand timepiece in the form of a wristwatch according to one embodiment of the invention will be described. As shown in FIGS. 1-3, the wristwatch comprises a case 1 over which a bezel 1a is provided with a crystal 2 provided through packing 2a over the bezel 1a. A timepiece module 3 is received within the case 1. A case back 4 is attached through a waterproof ring 4a to the lower end of the case 1. #1-#4 push bottom switches 5a-5d are provided on the side of the case 1 at 3 and 9 o'clock.

As shown in FIG. 2, the timepiece module 3 comprises a wheel train block 6, a circuit board 7, an antenna 8 and a power source which, for example, includes a battery 9, which are supported by a ring-like plastic module maintaining plate 10 (FIGS. 21A-21C) into the case 1. A solar panel 11 and a dial plate 12 are superposed on the wheel train block 6 in this order and attached by a support ring 13 to the wheel train block 6.

The wheel train block 6 comprises a plurality of wheel trains arranged in a planar manner, and has a chronograph function, which will be described in more detail later. The circuit board 7 is disposed under the wheel train block 6 to drive and control the same. The antenna 8 receives a standard time and frequency signal to set the time and is disposed within the timepiece module 3 at 12 o'clock so as to have a thickness smaller than the total thickness of the wheel train block 6 and the circuit board 7. The battery 9 supplies electric energy to the respective electric components of the wristwatch that required such energy. The battery 9 is disposed within the timepiece module 3 at 9 o'clock and has a thickness in the range of the total thickness of the wheel train block 6 and the circuit board 7.

As shown in FIGS. 4-16, the wheel train block 6 comprises a three-hand wheel train 15, a two-hand wheel train 16, a second-hand-dedicated wheel train 17, and a day indicator wheel train 18 integrated in substantially a planar manner between a ring-like plastic main plate 19 and a plastic wheel-train board 20. The second-, minute- and hour-hands 16a, 15b and 15c of the three-hand wheel train 15 are attached to the corresponding coaxial cylindrical axles at substantially the center of the timepiece module 3 so as to be turned by the #1 and #2 pulse motors 21 and 22. A 24-hour hand 15d is positioned within the timepiece module 3 at 9 o'clock so as to be turned by a wheel train 41.

As shown in FIGS. 4-9 and 13, in the two-hand wheel train 16 the minute hand 16a and the 24-hour hand 16b are attached to the corresponding coaxial tubular axles provided on the timepiece module 3 at 3 o'clock so as to be driven by the #3 pulse motor 23. As shown in FIGS. 4-9 and 15, in the second-hand-dedicated wheel train 17 a second hand 17a is provided on the timepiece module 3 at 6 o'clock so as to be driven by the #4 pulse motor 24. As shown in FIGS. 4-9 and 16, in the day indicator wheel train 18 the ring-like day indicator 26 is disposed concentrically on the main plate 19 so as to be rotated by the #5 pulse motor 25.

As shown in FIGS. 10A and 10B, each of the #1-#5 pulse motors 21-25 for the respective wheel trains 15-18 includes an energizing coil 27, a stator 28 and a rotor 29 such that NS magnetic fields produced by a required current flowing through the coil 27 rotate the rotor 29 through the stator 28. In this case, the rotor 29 is supported rotatably within a cavity in the stator 28 between the main plate 19 and the wheel train bridge 20.

Next, the respective wheel trains 15-18 will be described in order. As shown in FIGS. 7-12, the three-hand wheel train 15 comprises first and second wheel train systems driven by the #1 and #2 pulse motors 21 and 22, respectively. As shown in FIGS. 11 and 12, the first wheel train system comprises a fifth wheel and pinion set 30 driven by the #1 pulse motor 21 and a second wheel and pinion set 31, which is a second-hand wheel, driven by the fifth wheel and pinion set 30.

As shown in FIGS. 7-12, the second wheel train system comprises a intermediate wheel 32 rotated by the #2 pulse motor 22, a third wheel and pinion set 33 rotated by the intermediate wheel 32, a center wheel and pinion set 34, which is a second hand wheel, rotated by the third wheel and pinion set 33, a minute wheel 35 rotated by the center wheel and pinion set 34, a hour wheel 36, which is an hour-hand wheel rotated by the minute wheel 35, and a 24-hour hand wheel 37 that is caused to make a complete revolution in 24 hours due to rotation of the minute wheel 35 through a wheel train 41.

As shown in FIG. 11, the fifth wheel and pinion set 30 of the #1 wheel train system is supported rotatably between the main plate 19 and the wheel train bridge 20 such that the wheel of the set 30 is rotated by a pinion of the rotor 29 of the #1 pulse motor 21 in a meshed state. As shown in FIGS. 11 and 12, the second wheel and pinion set 31, which is the second hand wheel, has a second hand axle 31a supported rotatably at substantially the center of the timepiece module 3 between the wheel train bridge 20 and an intermediate bridge 38 attached to the main plate 19. A second hand 15a is attached to a lower end (see FIG. 11) of the second hand shaft 31a.

The intermediate bridge 38 includes a thin metal plate, for example of stainless steel, attached to the main plate 19 between the same and the wheel train bridge 20. As shown in FIGS. 11 and 12, the intermediate bridge 38 supports a hollow cylindrical holder 39, within which the second hand shaft 31a of the second wheel and pinion set 31 is received rotatably, at substantially the center of the time module 3. The cylindrical holder 39 is in turn received rotatably within a hollow cylindrical minute-hand shaft 34a of a center wheel and pinion set 34, which is a minute-hand wheel, so as to rotatably support the minute-hand shaft 34a with a minute hand 15b attached to a lower end of the shaft 34a. The wheel of the set 34 meshes rotatably with a pinion of the third wheel and pinion wheel 33.

As shown in FIG. 11, the intermediate wheel 32 of the #2 wheel train system is supported between the main plate 19 and the wheel train bridge 20 so as to be rotated by a pinion of the rotor 29 of the #2 pulse motor 22 in a meshed state. The wheel and pinion set 33 is supported rotatably between the main plate 19 and the intermediate bridge 38 such that the wheel thereof is rotated by a pinion of the intermediate wheel 32 in a meshed state.

The center wheel and pinion set 34 is disposed at the center of the main plate 19 such that there is a predetermined gap between a restricting part 19a (FIG. 12) of the main plate 19 and the wheel of the center wheel and pinion set 34 and that there is another ring-like gap between an inner periphery 19b of the opening in the main plate 19 and a pinion of the center wheel and pinion set 34, from the standpoint of position restriction. As shown in FIG. 17, the second-hand shaft 34a of the center wheel and pinion set 34 is accurately positioned by an assembly jig 1. The hollow cylindrical holder 39 attached to the intermediate bridge 38 can then be inserted rotatably into within the second-hand shaft 34a, thereby supporting the same rotatably.

As shown in FIG. 12, the minute wheel 35 is supported rotatably by an upright support shaft 40 attached to the intermediate bridge 38 such that the minute wheel 35 rotates, meshing with a cannon pinion of the center wheel and pinion set 34. The support shaft 40 of the minute wheel 35 is received within a hole 38a in the intermediate bridge 38 with a head 40a of the support shaft 40 held by a lower end 20a of the wheel train bridge 20.

As shown in FIGS. 11 and 12, the hour-hand wheel or hour wheel 36 is provided at substantially the center of the timepiece module 3 with a cylindrical shaft 36a supported by the minute-hand shaft 34a that is received rotatably within the cylindrical shaft 36a. The 12-hour hand 15c is attached to the lower end of the shaft 36a (in FIG. 11). A wheel of the set 36 meshes rotatably with a pinion of the minute wheel 35. Thus, the second-, minute- and hour-shafts 31a, 34a and 36a are disposed coaxially around the same axis.

As shown in FIGS. 7 and 12, the wheel train 41 includes a first intermediate wheel 42 and a second intermediate wheel (or 24-hour hand wheel) and pinion set 43 which reduce the rotational speed of the minute wheel 35 and transmit an resulting speed to the 24-hour hand wheel 37. As shown in FIG. 12, the first intermediate wheel 42 is pivoted at a support axle 19c to a lower end of the main plate 19 so as to mesh rotatably with a pinion of the minute wheel 35. As shown in FIG. 12, the second intermediate wheel and pinion set 43 is pivoted at a support axle 19d to the lower end of the main plate 19 such that a wheel of the set 43 meshes rotatably with the first intermediate wheel 41.

As shown in FIG. 12, in the 24-hour hand wheel 37 its shaft 37a is supported rotatably on the wheel train bridge 19 on the timepiece module 3 at the 9 o'clock position with the 24-hour hand 15d attached to the lower end of the shaft 37a. The wheel 37 meshes rotatably with a pinion of the second intermediate wheel and pinion set 43 so as to make a complete revolution in 24 hours. The 24-hour hand wheel 37, the first intermediate wheel 42, the second intermediate wheel and pinion set 43, the minute wheel 35, and the hour-hand wheel 36 are resiliently and rotatably supported by a day indicator maintaining plate 55 through resilient ring-like seats such as spring washers 36b, 37b and 48b.

As shown in FIGS. 7-9, and 13, the two-hand wheel train 16 is disposed over the timepiece module 3 at the 3 o'clock position such that the minute and 24-hour hands 16a and 16b are turned by the #3 pulse motor 23, as shown in FIG. 1. More particularly, as shown in FIGS. 7-9 and 13, the two-hand wheel train 16 comprises an intermediate wheel and pinion set 45 rotated by the #3 pulse motor 23, a center wheel and pinion set 46, which is a minute-hand wheel, rotated by the intermediate wheel and pinion set 45, a minute wheel and pinion set 47 rotated by the center wheel and pinion set 46, and a 24-hour hand 48 that is caused to make a complete revolution in 24 hours by the minute wheel and pinion set 47, which is rotated by the center wheel and pinion set 46.

As shown in FIG. 13, the intermediate wheel and pinion set 45 of the two-hand wheel train 16 has a shaft which is supported between the main plate 19 and the wheel train bridge 20 such that a wheel of the set 45 meshes rotatably with a pinion of the rotor 29 of the #3 pulse motor 23. The center wheel and pinion set 46, which involves the minute-hand wheel, has a shaft 46a supported between the main plate 19 and the wheel train bridge 20 in the timepiece module 3 at the 3 o'clock position. A minute hand 16a is attached to the lower end of the shaft 46a. In this state, a wheel of the center wheel and pinion set 46 is rotated by a pinion of the intermediate wheel and pinion set 45 in a meshed state.

The minute wheel and pinion 47 has a shaft supported rotatably between the main plate 19 and the wheel train bridge 20 such that a wheel of the set 47 meshes rotatably with a cylindrical pinion of the center wheel and pinion set 46. A 24-hour hand wheel 48 involves a 24-hour wheel having a hollow cylindrical shaft 48a provided in the timepiece module 3 at 3 o'clock with the minute-hand shaft 46a of the center wheel and pinion set 46 received rotatably within the cylindrical shaft 48a, which is supported by the minute-hand shaft 46a. The wheel of the set 48 meshes with a pinion of the minute wheel and pinion set 47 so as to make a complete revolution in 24 hours.

As shown in FIG. 1, the second-hand-dedicated wheel train 17 is disposed in the timepiece module 3 at 6 o'clock such that the second-hand 17a is turned by the #4 pulse motor 24. More particularly, as shown in FIGS. 7-9 and 15, the second-hand-dedicated wheel train 17 comprises a fifth wheel and pinion set 50 rotated by the #4 pulse motor 24, and a second wheel and pinion set 51, which involves a second-hand wheel, rotated by the fifth wheel and pinion set 50.

As shown in FIG. 15, the fifth wheel and pinion set 50 has a shaft supported rotatably between the main plate 19 and the wheel train bridge 20 such that a wheel of the set 50 meshes rotatably with a pinion of the rotor 29 of the #4 pulse motor 24. The second wheel and pinion set 51, which involves the second hand wheel, has a shaft 51a supported rotatably between the main plate 19 and the wheel train bridge 20 with a second hand 17a attached to the lower end of the shaft 51a (in FIG. 15) such that a wheel of the second wheel and pinion set 51 is rotated by a pinion of the fifth wheel and pinion set 50 in a meshed state.

The day indicator 26 is driven through the day indicator wheel train 18 by the #5 pulse motor 25. As shown in FIGS. 7-9 and 16, the day indicator wheel train 18 comprises a fifth wheel and pinion set 52 rotated by the #5 pulse motor 25, and an intermediate wheel and pinion set 53 rotated by the fifth wheel and pinion set 52, a date indicator driving wheel and pinion set 54 rotated by the intermediate wheel and pinion set 53, and a day indicator 26 rotated by the day indicator driving wheel and pinion set 54. As shown in FIG. 16, the fifth wheel and pinion set 52 of the day indicator wheel train 18 has a shaft supported rotatably between the main plate 19 and the wheel train bridge 20 such that a wheel of the set 52 is rotated by a pinion of the rotor 29 of the #5 pulse motor 25 in a meshed state.

As shown in FIG. 16, the intermediate wheel and pinion set 53 of the day indicator wheel train 18 has a shaft supported rotatably between the main plate 19 and the wheel train bridge 20 such that a wheel of the set 53 is rotated by a pinion of the fifth wheel and pinion set 52 in a meshed state. The day indicator driving wheel and pinion set 54 is pivoted at a downward support axle 19e integral with the lower end of the main plate 19 such that a wheel of the set 54 meshes rotatably with a pinion of the intermediate wheel and pinion set 53.

As shown in FIGS. 6, 7 and 18, the ring-like day indicator 26 is disposed concentrically within a raised ring-like guide 19f provided concentrically on, and substantially equal in outer diameter to, the main plate 19 such that there is a substantially constant-width ring-like gap between the day indicator 26 and the outside guide 19f. Dates are indicated on the day ring 26 at predetermined intervals. The ring-like day indicator 26 has gear teeth 26a arranged along an inner periphery thereof and meshing with a pinion of the day indicator driving wheel 54 (see FIG. 16) so as to make a complete revolution in a month. As shown in FIGS. 13 and 15, the day indicator 26 has a thinned inner periphery portion including the gear teeth 26a at which the day indicator 26 is supported rotatably by a maintaining plate 55.

As shown in FIGS. 18 and 19, the main plate 19 has therein a plurality of (for example, three) guide holes 76 arranged at the 12, 4 and 10 o'clock positions along the ring-like gap between the main plate 19 and the inside day indicator 26 and overlapping the day indicator 26 into which holes a like number of guide pins 77 will be inserted for positioning purposes.

As shown in FIGS. 6, 11-16 and more particularly FIG. 13, a ring-like day indicator maintaining plate 55 has a diameter somewhat larger than the inner diameter of the day indicator 26 and is disposed concentric with the day indicator 26 so as to support the day indicator 26 rotatably at its thinned peripheral part. The plate 55 is fixed to the main plate 19 by two screws 56 in a state in which the day indicator maintaining plate 55 supports the 24-hour hand wheel 48 of the second-hand wheel train 16 at a protrusion (not shown) provided on the outer periphery thereof. The 24-hour hand wheel 48 has gear teeth of a reduced thickness provided along the outer periphery thereof so as not to interfere with the inner wheel teeth 26a of the day indicator 26.

As shown in FIGS. 13 and 14, each screw 56 is composed of a head 57 and a screw part 58. The head 57 is composed of a truncated conical part 57a disposed in a complementary hole 55b provided in the day indicator maintaining plate 55 and a disk part 57b integral with the head part 57a received in a complementary recess 59 in the main plate 19.

In order to assemble the day indicator 26 in place on the main plate 19, the main plate 19 is first disposed on an assembly jig G2 such that the plurality of guide holes 76 provided in the main plate 19 align with the like number of pin holes 78 provided in the jig G2 (step 1). Each pin hole 78 in the jig G2 is somewhat larger than a respective guide hole 76 in the main plate 19.

Then, as shown in FIG. 19, the ring-like day indicator 26 is disposed substantially concentrically within the circular guide 19f provided on the main plate 19 such that a ring-like gap is formed between the guide 19f and the day indicator 26 (step 1). A plurality of guide pins 77 each having an upper tapering part and a lower thicker part are then inserted from below into the like number of aligned holes 78 and 76 provided in the jig G2 and the main plate 19 so as to come gradually into contact with the outer periphery 26b of the day indicator 26 at the tapering parts thereof, thereby positioning the day indicator 26 in place relative to the main plate 19 (step 3).

The positioned day indicator 26 is then supported ratatably by the day indicator maintaining plate 55 against the main plate 19 (step 4) such that the day indicator 26 overlap rotatably in its thinned inner periphery part with the day indicator maintaining plate 55. The day indicator maintaining plate 55 is then fixed to the main plate 19 with the screws 56. Then, the guide pins 77 are removed from the main plate 19, which is then removed from the jig G2.

As shown in FIGS. 8, 11-13, attached to the wheel train bridge 20 for the wheel train block 6 are a leaf spring 61 that has #1, #2 and #3 spring parts 61a, 61b and 61c to elastically press the ends of the second-, minute- and second-hand shafts 31a, 46a, and 51a of the three-hand, two-hand, and second-hand-dedicated wheel trains 15, 16 and 17, and a plurality of support springs 61d and 61e abutting elastically on the circuit board 7.

As shown in FIGS. 2 and 20-22B, the timepiece module 3 to which the wheel train block 6, circuit board 7, antenna 8 and battery 9 are attached is incorporated into the case 1 by the module maintaining plate 10. In this timepiece module 3, the circuit board 7 is disposed below the wheel train block 6. The antenna 8 is disposed in the timepiece module 3 at 120'clock in a range of the total thickness of the wheel train block 6 and the circuit board 7 with a part of the antenna 8 underlying the day indicator 26 of the day indicator wheel train 18. The battery 9 is disposed in the timepiece module 3 at the 9 o'clock position with a part thereof disposed below the day indicator 26 of the day indicator wheel train 18, the three-hand wheel train 15 and the 24-hour hand wheel 43. The module maintaining plate 10 supports these components into the case 1.

As shown in FIGS. 8 and 9, the upper portions of the antenna 8 and the battery 9 are received in cavities 62a and 62b, respectively, provided in the main plate 19. In the wheel train block 6, a pulse motor having the highest drive frequency, for example the #4 pulse motor 24 for the second-hand-dedicated wheel train 17, is disposed at a remotest position from the antenna 8 so as not to deteriorate the reception sensitivity of the antenna 8.

A solar panel 11 and a transparent dial plate 12 are disposed on the wheel train block 6 and attached by a holder ring 13 to the wheel train block 6. The solar panel 11 receives external light through the transparent dial plate 12, thereby generating an electromotive force, which is fed to the battery 9 and used as a part of the energy fed from the battery 9. As shown in FIG. 1, hour numerals 12a are printed on the dial plate 12 with a window 12b through which a date displayed on the day indicator 26 is visible. A 24-hour dial around which the 24-hour hand 15d of the three-hand wheel train 15 sweeps is printed on the dial plate 12 at 9 o'clock. A concentric-circlular 60-minute- and 24-hour-graduated subdial 12d around which the minute hand 16a and the 24-hour hand 16b of the two-hand wheel train 15 sweeps are printed on the dial plate 12 at 3 o'clock. A 60-second-scaled subdial 12e around which the second hand 17a of the second-hand-dedicated wheel train 17 sweeps is printed on the dial plate 12 at 9 o'clock.

As shown in FIG. 20, the timepiece module 3 is positioned in the case 1 by the module maintaining plate 10 disposed therebelow. As shown in FIGS. 21A and 21b, the plastic module maintaining plate 10 has a gourd-shaped opening 10a therein through which the battery (not shown) received in the battery reception cavity 62b can be exchanged and through which leads (not shown) are connected between the circuit board and another electronic component (not shown) provided on an inner surface of the case back around the center thereof. A plurality of position restrictors 10b are disposed along the outer periphery of the module maintaining plate 1 for position restiction.

As shown in FIGS. 22A and 22B, the timepiece module 3 is disposed within the case 1 through the ring-like panel cover 63 disposed concentrically under the crystal 2. The plurality of protrusions 10b of FIGS. 21A and 21B provided along the outer periphery of the module maintaining plate 10 are fitted into the like number of pairs of cavities 64 and 65 provided on the inner and outer peripheries of the case 1 and the whole of the main plate 19 and wheel train bridge 20 provided at the same positions as the protrusions 10b so as to position the timepiece module 3.

In use, the operative mode of this wristwatch is changed to any desired one of a basic timepiece mode, a chronograph mode, a world time mode, an alarm mode, and a time set mode by operating a corresponding one of the #1-#4 push button switches 5a-5d. In the basic timepiece mode, the present time is displayed; in the chronograph mode, time is measured; in the world time mode, the respective times of the cities in the world are displayed; in the alarm mode, an alarm time is displayed; and in the time set mode, the time is set. These modes will be described sequentially next.

In FIG. 1, in the basic timepiece mode the #2 pulse motor 22 of the three-hand wheel train 15 operates to cause the minute and 12-hour hands 15b and 15c and the 24-hour hands 15d to sweeps around the dial 12 and the subdial 12c, respectively, thereby indicating the time in minutes and hours in the 12- and 24-hour systems. Simultaneously, the #4 pulse motor 24 of the second-hand-dedicated wheel train 17 operates to turn the second hand 17a, thereby indicating a “second” time. In addition, the #5 pulse motor 25 of the day indicator wheel train 18 operates to turn the day indicator 26, thereby indicating the present date in the window 12b of the dial plate 12. Since at this time the #1 pulse motor 21 of the three-hand wheel train 15 does not operate, the second hand 15a is at a stop at a reference (or 12 o'clock) position. Since the #3 pulse motor 23 of the two-hand wheel train 16 does not operate either, the minute and 24-hour hands 16a and 16b are at a stop at the reference position.

When the #4 push button switch 5d is operated in the basic timepiece mode, the operative mode changes to the chronograph mode. At this time, the second hand 17a of the second-hand-dedicated wheel train 17 is reset to the reference position while the second, 12-hour and 24-hour hands 15b, 15c and 15d of the three-hand wheel train 15 and the day indicator 26 of the day indicator wheel train 18 continue their operations performed so far, thereby indicating the reference time. When in this state the #4 push button switch 5d is again operated, the chronograph mode starts, the #1 pulse motor 21 of the three-hand wheel train 15 operates, thereby turning the second hand 15d. Simultaneously, the #4 pulse motor 24 of the second-hand-dedicated wheel train 17 operates to turn the second hand 17a, which causes the #3 pulse motor 23 of the second hand wheel train 16 to operate to turn the minute and 24-hour hands 16a and 16b.

At this time, the #1 pulse motor 21 of the three-hand wheel train 15 causes the second hand 15a to turn at a speed of one revolution per minute. The #4 pulse motor 24 of the second-hand-dedicated wheel train 17 causes the second hand 17a to turn at a high speed of one revolution per second. The #3 pulse motor 23 of the two-hand wheel train 16 turns the minute hand 16a at a speed of one revolution in 60 minutes and the 24-hour hand 16b at a speed of one revolution per 24 hours. Thus, the second hand 17a of the second-hand-dedicated wheel train 17, the second hand 15a of the three-hand wheel train 15 and the minute hand 16a and 24-hour hand 16b of the two-hand wheel train 16 are turned to measure time.

When the #4 push button switch 5d is operated again in this state, the chronograph mode stops, and the second hand 17a of the second-hand-dedicated wheel train 17, the second hand 15a of the three-hand wheel train 15, and the minute hand 16a and 24-hour hand 16b of the two-hand wheel train 16 stop, thereby displaying the measured time. Then, when the #4 push button switch 5d is again operated, the chronograph mode again starts, thereby starting time measurement as in the above case. When the #4 push button switch 5d is once again operated, the chronograph mode stops and the measured time is displayed. When the second push button switch 5b is then operated, the basic timepiece mode is restored.

When a user operates the #1 push button switch 5a in the basic timepiece mode, the operative mode is changed to the world time mode. At this time, the second hand 15a of the three-hand wheel train 15 indicates a particular one of the local city names, excluding the name of the city where the user is now, displayed on the ring-like panel cover 63, the minute hand 16a and the 24-hour hand 16b of the two-hand wheel train 16 indicate the time of the time zone of the local city whose name is indicated by the second hand 15a, and the second hand 17a of the second-hand-dedicated wheel train 17 indicates both the “second” times of the time zones of that city and the city where the user are t now. Both the “second” times are the same. The minute, 12-hour and 24-hour hands 15b, 15c and 15d of the three-hand wheel train 15 and the day indicator 26 of the day indicator wheel train 18 continue their operations performed so far, thereby indicating the time of the time zone of the city where the you are now.

The respective city names are printed on the panel cover 63 at intervals of two minutes with a reference city name printed at a 12 o'clock position of GMT. When the #1 push button switch 5a is pushed and then once more pushed in one second, the second hand 15a of the three-hand wheel train 15 moves, thereby indicating an adjacent city name. This causes the minute hand 16a and 24-hour hand 16b of the two-hand wheel train 16 to indicate a local time of the adjacent city. When the #1 push button switch 5a is operated while operating the #2 push button switch 5b, the home time and the local time change places. When only the #2 push button switch 5b is operated, the basic timepiece mode is restored.

When the #3 push button switch 5c is operated in the basic timepiece mode, the operative mode changes to the alarm mode. At this time, the second hand 15a of the three-hand wheel train 15 indicates “ON” displayed in the vicinity of the 11 o'clock position, and the second hand 16a and 24-hour hand 16b of the two-hand wheel train 16 indicate an alarm time. The second hand 17a of the second-hand-dedicated wheel train 17, the minute, 12-hour and 24-hour hands 15b, 15c and 15d of the three-hand wheel train 15, and the day indicator 26 of the day indicator wheel train 18 continue their operations performed so far, thereby indicating the reference time. When the #4 push button switch 5d is operated, the basic timepiece mode is restored.

When the #2 push button switch 5b is operated in the basic timepiece mode, the operative mode changes to the time set mode. At this time, the second hand 15a of the three-hand wheel train 15 indicates “Y” (Yes) displayed in the vicinity of the 3 o'clock position, and the minute hand 16a and 24-hour hand 16b of the two-hand wheel train 16 indicate a result of the last reception by the antenna 8. The second hand 17a of the second-hand-dedicated wheel train 17 and the minute, 12-hour and 24-hour hands 15b, 15c and 15d of the three-hand wheel train 15 and the day indicator 26 of the day indicator wheel train 18 continue their operations performed so far, thereby indicating the reference time.

When in this state the #2 push button switch 5b is again operated for two seconds, the second hand 15a of the three-hand wheel train 15 indicates “READY” displayed in the vicinity of the 7 o'clock position, the second hand 17a of the second-hand-dedicated wheel train 17 is returned to the reference position and the antenna 8 is caused to receive a standard time and frequency signal.

As described above, according to this wristwatch, the wheel train block 6 having the chronograph function comprises the in-plane arrangement of the plurality of wheel trains; that is, the three-hand wheel train 15, the two-hand wheel train 16, the second-hand-dedicated wheel train 17, and the day indicator wheel train 18. Thus, the whole thickness of the wheel train block 6 is restricted. Thus, the assembling operation is efficiently achieved. Since the circuit board 7 is disposed below the wheel train block 6 having the in-plane arrangement of the plurality of wheel trains without being divided into parts, the assembly efficiency is improved. Since each of the antenna 8 and the battery 9 is disposed compactly beside the totality of the wheel train block 6 and the circuit board 7 so as to be thinner than their total thickness. Thus, the whole timepiece does not increase in thickness.

The wheel train block 6 comprises the three-hand wheel train 15 in which the #1 and #2 pulse motors 21 and 22 turn the second, minute and 12-hour hands 15a, 15b and 15c attached to the corresponding coaxial shafts 31a, 34b and 36a, respectively; the two-hand wheel train 16 in which the #3 pulse motor 23 turns the minute and hour hands 16a and 16b attached to the corresponding coaxial shafts, 46a and 48a; the second-hand-dedicated wheel train 17 in which the #4 pulse motor 24 turns the second hand 17a alone; and the day indicator wheel train 18 in which the #5 pulse motor 25 turns the day indicator 26. Thus, these wheel trains 15-18 each can be driven independently and hence changed to either a time system or a chronograph system as required, thereby providing various combinations of multi-function displays based on these systems.

For example, as in the above embodiment, the #2 pulse motor 22 that turns the minute and 12-hour hands 15b and 15c of the three-hand wheel train 15, the #4 pulse motor 24 that turns the second hand 17a of the second-hand-dedicated wheel train 17, and the #5 pulse motor 25 that turns the day indicator 26 of the day indicator wheel train 18 can be driven for the time system. The #1 pulse motor 21 that turns the second hand 15a of the three-hand wheel train 15, the #3 pulse motor 23 that turns the minute and hour hands 16a and 16b of the second-hand wheel train 16, and the #4 pulse motor 24 that turns the second hand 17a of the second-hand-dedicated wheel train 17 can be driven for the chronograph system.

For example, the #1 and #2 pulse motors 21 and 22 that turn the second, minute, 12-hour, and 24-hour hands 15a, 15b, and 15c and 15d of the three-hand wheel train 15, and the #5 pulse motor 25 that turns the day indicator 26 of the day indicator wheel train can be driven for the time system. The #3 pulse motor 23 that turns the minute and hour hands 16a and 16b of the two-hand wheel train 16 and the #4 pulse motor 24 that turns the second hand 17a of the second-hand-dedicated wheel train 17 can be driven for the chronograph system. Alternatively, the respective pulse motors 21-25 can be driven in other different combinations of the time and chronograph systems as required and can also provide various functions including indicating the world time.

In this wristwatch, the three-hand wheel train 15, the two-hand wheel train 16, the second-hand-dedicated wheel train 17 and the day indicator wheel train 18 are assembled with the main plate 19 and the train wheel bridge 20 in a planar manner. In addition, in assembly, these wheel trains 15-18 operate independently and can be incorporated separately into the case, thereby further increasing the assembly efficiency.

In this case, the day indicator 26 of the day indicator wheel train 18 disposed concentrically on the main plate 19 overlaps with each of the antenna 8 and the battery 9 disposed at different positions in the same plane. The day indicator 26 is very thin, and the antenna 8 and the battery 9 are incorporated compactly. Thus, the whole thickness of the timepiece module 3 and hence the whole wristwatch do not increase, which brings about a wristwatch reduced in size.

In this wristwatch, the main plate 19, where the wheel trains 15-17 are arranged, has thereon the ring-like raised guide 19f formed concentric therewith and having substantially the same outer diameter as the main plate for position restricting purposes. The day indicator 26 of the day indicator wheel train 18 is disposed substantially concentrically within the ring-like guide 19f with a ring-like gap between the day indicator 26 and the outside guide 19f. The wheel trains 15-17 are arranged within the day indicator 26. The main plate 19 therein has the plurality of guide holes 76 arranged along the ring-like gap between the main plate 19 and the day indicator 26.

When the plurality of pins 77 are inserted into the like number of guide holes 76, the day indicator 26 is easily positioned accurately in place within the ring-like guide 19f on the main plate 19 due to contact with the pins 77. In this case, since only the ring-like guide 19f provided concentrically on the main plate and the plurality of guide holes 76 in the ring-like gap on the main plate 19 within the guide 19f are required. Thus, this positioning structure is simple, which allows the assembling operation to be achieved easily.

The day indicator 26 is supported rotatably and concentrically on the main plate 19 by the day indicator maintaining plate 55 so as to overlap in inner periphery with the same. Thus, the area of the day indicator maintaining plate 55 that is in contact with the day indicator 26 is not large. In assembly, the day indicator 26 is accurately positioned relative to the main plate 19. Thus, the plate 55 can be easily and accurately attached to the main plate 19.

When the day indicator maintaining plate 55 is fixed to the main plate 19 by the two screws 56, a truncated conical head part 57a of a head 57 of each screw 56 is received in a complementary-shaped hole 55b formed in the day indicator maintaining plate 55, a disk part 57b of the head 57 is received in a complementary-shaped recess 59 provided in the main plate 19, and an outer threaded stem 58 of the screw 56 is screwed into an inner screwed hole 60a in the cylindrical female screw 60 imbedded in the main plate 19. Thus, the tightening force of the screws 56 to the day indicator maintaining plate 55 is constant and the day indicator maintaining plate 55 is fixed to the main plate 19 without being deformed such that the day indicator 26 is supported rotatable.

Thus, the solar panel 11 and the dial plate 12 are assembled in a flat state over the day indicator maintaining plate 55. In addition, the spacing between the dial plate 12 and each of the hands 15a-15d, 16a, 16b and 17a of the respective wheel trains 15-17 is sufficient to ensure that these hands are prevented from coming into contact with the dial plate 12 and can sweep well around the dial plate 12.

While in the timepiece module 3 of the embodiment it is illustrated that each of the antenna 8 and the battery 9 is disposed below the day indicator 26 so as to overlap the same and that the battery 9 is disposed below each of the wheel train of the three-hand wheel train 15 and the 24-hour hand wheel 43 so as to overlap with the same, the antenna 8 and the battery 9 may be disposed on the opposite sides of the whole of the wheel train block 6 and the circuit board 7 so as not to overlap with the wheel train block 6, as in the first modification of FIG. 23. Also in this case, the height of each of the antenna 8 and the battery 9 is required to be in a range of the total thickness of the wheel train block 6 and the circuit board 7. The timepiece module 3 is supported within the case 1 by the module maintaining plate 10. Thus, the wristwatch of the first modification is thinner than that of the embodiment.

While in the embodiment and the first modification the timepiece module, which comprises the wheel train block 6, circuit board 7, antenna 8 and battery 9 is illustrated as incorporated into the case 1 with the module maintaining plate 10, the wheel train block 6, circuit board 7, antenna 8 and battery 9 may be assembled with the housing 70, thereby forming the timepiece module 71, which is then assembled into the case 1 with the module maintaining plate 10, as shown in a second modification of FIG. 24. In this case, the whole thickness of the wristwatch increases solely by the thickness of the housing 70, but the timepiece module 71 is easy to assemble, thereby improving productivity.

While in the present embodiment and the first and second modifications the multi-hand wristwatches according to the present invention have been described, the present invention is also applicable to other pocket watches, traveling watches, alarm clocks, table clocks and wall clocks.

### Summary of the Embodiment and Modifications

As shown in FIGS. 1-24, a timepiece with a calendar function comprises: a main plate (19); and a ring-like day indicator (26) of a day indicator wheel train (18) provided rotatable concentrically with and on the main plate, the main plate having a plurality of holes (76) arranged circumferentially along the outer periphery of the day wheel disposed concentrically with and on the main plate for receiving the plurality of holes in the main plate receiving a like number of guide pins (77) so as to come into contact with the outer periphery of the day indicator disposed concentrically with and on the main plate to position the day indicator concentrically with and on the main plate.

According to this arrangement, when the plurality of pins are inserted into the plurality of holes in the main plate arranged circumferentially along the outer periphery of the day wheel disposed concentrically with and on the main plate, the pins cooperate to come into contact with the day indicator to adjust the position of the day indicator in radial directions and finally position the day indicator exactly concentrically with and on the main plate. This positioning structure is simple and renders the assembling operation easy because it is only required that the main plate has the plurality of holes arranged along the outer periphery of the day indicator when the same is disposed concentrically with and on the main plate and that the like number of guide pins are inserted into the plurality of holes for positioning purposes.

As shown in FIGS. 1-16, the timepiece may further comprise a day indicator maintaining plate (55) provided concentrically overlapping in inner periphery with the day indicator (26) so as to support the day indicator rotatable.

Thus, according to this arrangement, the area of the day indicator maintaining plate that is contact with the day indicator is small and it is ensured that the day indicator maintaining plate supports the day indicator rotatable. In assembly, since the day indicator is accurately positioned relative to the main plate, the day indicator maintaining plate can be attached easily and accurately to the main plate.

In the timepiece of FIGS. 13 and 14, the day indicator maintaining plate (55) is fixed to the main plate (19) by screws (56) that each comprise a head (57) that includes a truncated conical part (57a) received in a complementary-shaped hole (55b) provided in the day indicator maintaining plate and a disk-like part (57b) integral with the conical head part received in a complementary recess (59) provided in the main plate and an outer threaded stem (58) integral with the head screwed into an inner threaded hole (60a) in the main plate.

Thus, according to this arrangement, the tightening force of the screws to the day indicator maintaining plate is maintained substantially constant. Consequently, the day indicator maintaining plate is prevented from being deformed, which is liable to occur if conventional screws are used. The day indicator maintaining plate is well fixed to the main plate in a flat state and the day indicator is well supported rotatable.

As shown in FIGS. 1-22B, a method of assembling a timepiece with a calendar function is provided which comprises the steps of: disposing a day indicator (29) on a main plate (19); and inserting a plurality of pins (77) provided on an assembly jig (G2) into a plurality of holes (78) provided in the main plate so as to come into contact with the outer periphery of the day indicator, thereby adjusting the position of the day indicator in radial directions to position the day indicator exactly concentrically with and on the main plate.

According to this arrangement, when the ring-like day indicator is desired to be disposed exactly concentrically with and on the main plate, the day indicator is first disposed on the main plate. When the plurality of pins provided on the assembly jig are then inserted into the plurality of holes in the main plate, they cooperate to come into contact with the outer periphery of the day indicator, thereby adjusting the position of the day indicator in radial directions to position the day indicator exactly concentrically with and on the main plate. This positioning method is simple and the number of parts required for this positioning operation is low.

As shown in FIGS. 1-24, the plurality of hand wheel trains (three-hand wheel train (15), two-hand wheel train (16), second-hand-dedicated wheel train (17)) may be arranged in a planar manner on the main plate so as to form a wheel train block having a chronograph function. The timepiece may further comprise a circuit board (7) disposed on the wheel train block for driving the same; an antenna (8) disposed at a position beside the totality of the wheel train block and the circuit board within their total thickness for receiving a standard time and frequency signal; and a power source (9), provided beside the totality of the wheel train block and the circuit board at a different position from that at which the antenna is disposed, for feeding electric power to the circuit board and other required elements.

Thus, according to this arrangement, the timepiece has a simple structure. In assembly, the day indicator can be easily and accurately positioned relative to the main plate.

More particularly, as described above, according to this timepiece, the wheel train block having the chronograph function comprises the in-plane arrangement of the plurality of wheel trains. Thus, the whole wheel train block is thin and the assembling operation is efficiently achieved. Since in assembly the circuit board can be easily in an aligning manner disposed below the wheel train block having the in-plane arrangement of the plurality of wheel trains without being divided into parts, the assembly efficiency is improved. Each of the antenna and the power source is disposed compactly beside the totality of the wheel train block and the circuit board in the range of their total thickness. Thus, the whole timepiece does not increase in thickness.

As shown in FIGS. 1-24, in the timepiece the day indicator (26) of the day indicator wheel train (26) overlaps with the antenna (8) and the power source (9) at different positions in substantially the same plane.

Thus, according to this arrangement, the day indicator of the day indicator wheel train overlaps with each of the antenna and the power source disposed at different positions in substantially the same plane. The day indicator 26 is very thin. Thus, the whole thickness of the timepiece module 3 and hence the whole wristwatch do not substantially increase. The antenna and the power source are incorporated compactly into the timepiece, thereby reducing the whole size of the timepiece.

Various modifications and changes may be made thereunto without departing from the broad spirit and scope of this invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2005-312667 filed on October 27 and including specification, claims, drawings and summary. The disclosure of the above Japanese patent application is incorporated herein by reference in its entirety.

What is claimed is:

1. A timepiece with a calendar function comprising:
a main plate; and
a ring-like day indicator of a day indicator wheel train provided rotatable concentrically with and on the main plate,
the main plate having a plurality of holes arranged circumferentially along the outer periphery of the day wheel disposed concentrically with and on the main plate for receiving a like number of guide pins so as to come into contact with the outer periphery of the day indicator disposed concentrically with and on the main plate to position the day indicator concentrically with and on the main plate.

2. The timepiece of claim 1, further comprising a day indicator maintaining plate provided concentrically overlapping in inner periphery with the day indicator so as to support the day indicator rotatable on the main plate.

3. The timepiece of claim 2, wherein the day indicator maintaining plate is fixed to the main plate by screws that each comprise a head that includes a truncated conical part received in a complementary-shaped hole provided in the day indicator maintaining plate and a disk-shaped part integral with the conical head part received in a complementary-shaped recess provided in the main plate and an outer threaded stem integral with the disk-shaped part screwed into an inner threaded hole provided in the main plate.

4. A method of assembling a timepiece with a calendar function, the method comprising the steps of:
disposing a day indicator on a main plate; and
inserting a plurality of guide pins provided on an assembly jig into a plurality of holes provided in the main plate so as to come into contact with the outer periphery of the day indicator, thereby adjusting the position of the day indicator in radial directions to finally position the day indicator exactly concentrically with and on the main plate.

5. The timepiece of claim 1, wherein the plurality of hand wheel trains are arranged in a planar manner on the main plate so as to form a wheel train block, the wheel train block having a chronograph function;
and further comprising:
a circuit board disposed on the wheel train block for driving the same;
an antenna disposed at a position beside the totality of the wheel train block and the circuit board within their total thickness for receiving a standard time and frequency signal; and
a power source, arranged beside the totality of the wheel train block and the circuit board at a different position from that at which the antenna is disposed, for feeding electric power to the circuit board and other required elements.

6. The timepiece of claim 5, wherein the day indicator of the day indicator wheel train overlaps with the antenna and the power source at different positions in the same plane.
